(19) United States
(12) Patent Application Publication
(10) Pub. No.: US 2010/0008649 A1
(43) Pub. Date: Jan. 14, 2010

(54) INFORMATION RECORD/REPRODUCTION APPARATUS AND INFORMATION RECORD/PLAYBACK METHOD

(76) Inventors: Akinobu Watanabe, Kawasaki (JP); Tsutomu Usui, Yokohama (JP); Hiroyuki Marumori, Yokohama (JP); Toshihiro Kato, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/430,233

(22) Filed: Apr. 27, 2009

(30) Foreign Application Priority Data
Jul. 11, 2008 (JP) 2008-180886

(51) Int. Cl. H04N 5/00

(52) U.S. Cl. 386/117

(57) ABSTRACT

A hybrid video camera with a built-in hard drive and optical disk drive plus removable media read/write unit is disclosed. The video camera has a face detection function, which is used to split a video stream of a scene shot at the position of a frame containing no human face images, thereby realizing automatic scene-split dubbing without impairing the scene continuity. With this feature, it is possible, when watching a home video movie, to avoid sudden stop of playback of the scene otherwise occurring due to improper splitting of the scene at its run-on part during dubbing by letting the scene be dividedly recorded on a plurality of disks.

### INCORPORATION BY REFERENCE

The present application claims priority from Japanese application JP 2008-180886 filed on Jul.11, 200, the content of which is hereby incorporated by reference into this application.

### BACKGROUND OF THE INVENTION

The present invention relates to an information record/reproduction apparatus and information record/playback methodology.

Person recognition and face detection technologies have recently been built in surveillance systems, digital still cameras and digital video cameras or camcorders. Use of these technologies results in commercial popularization of advanced imager products, including a still camera of the type having its ability to recognize the face of a subject of shooting, e.g., person, and using the resultant information for focusing and exposure settings.

For example, Japanese Patent Bulletin JP-A-2007-19845 relates to a “surveillance camera, surveillance method and surveillance program,” and discloses in its paragraph [0028] that the camera's recognized person information is used to perform stream division in a way such that a “moving-picture divider 60 splits a plurality of frame images, which are received from an image storage 30, into a plurality of streams with respect to each person as extracted in a moving-picture extraction unit 55.”

In addition, prior known hybrid digital video cameras having a plurality of types of built-in recording media include a camcorder capable of performing video dubbing to removable media within the camera per se, called the in-camera dubbing.

Examples of the record media housed in such hybrid camcorder are undetachable fixed storages, such as large-capacity hard disk drive (HDD), semiconductor flash memory, etc. Other examples are removable storage media, such as optical disks—e.g., digital versatile disc (DVD), Blu-ray™ disc (BD) or else—and secure digital (SD) cards or secure memory cards or like solid-state storages.

### SUMMARY OF INVENTION

Known hybrid digital video cameras having multiple built-in recording media include a camcorder capable of performing in-camera video dubbing to removable media.

Examples of the record media housed in such hybrid camcorder are fixed storages, such as large-capacity HDD, flash memory or else, and removable media, such as optical disks—e.g., DVD or BD—and SD cards or the like.

The fixed storage media as built in a hybrid video camera are large in storage capacity and simultaneously offer long-time recordability. On the other hand, for purposes of long-term data saving along with browsing and playback of videos captured, it is general to use a method of dubbing a video saved on HDD to removable media, such as optical disks or else.

In such known technologies, most removable media are less in storage capacity than camera built-in fixed media. For example, an 8 cm BD having a single recording layer is about 7.5 gigabytes (GB) in storage capacity. An SD card is 2 GB in maximum capacity. A secure digital high capacity (SDHC) card is 32 GB in max capacity. Regarding the in-camera fixed media, an HDD, which is one known example thereof, has a storage capacity of 60 GB or more. A flash memory, which is another example, is 32 GB in capacity.

Under these circumstances, when performing dubbing of a video from a fixed media to removable media, a problem occurs as to the failure to record an entirety of video data on a single piece of removable medium. In such case, the only remedy for this problem is to perform dubbing to each of a plurality of removable media after having divided the video into two or more parts.

In this event, it is general to simply split image data having been recorded at almost equal interval of time period. However, this method accompanies a penalty which follows: a scene to be played back continuously is undesirably interrupted in a midstream thereof and its playback suddenly stops when watching and enjoying the recorded image as a home-made video movie.

The above-cited JP-A-2007-19845 is silent about this point.

This invention has been made in view of the above-stated technical background, and an object of the invention is to provide an information record/reproduction method and apparatus capable of appropriately performing dubbing while improving the usability for users.

To attain the foregoing object, this invention provides a technique for performing the dubbing using a specific kind of marking codes, which are different from usually used marks, to separate or “split” a video stream, although this invention should not exclusively be limited to embodiments as disclosed herein.

According to the invention, it is possible to provide an information record/reproduction method and apparatus capable of appropriately performing dubbing while retaining increased usability for users.

### BRIEF DESCRIPTION OF DRAWINGS

FIG. 1 shows a block diagram of a first embodiment of the present invention.

FIG. 2 is a diagram showing pictorial representation of one exemplary video data used in the first embodiment.

FIG. 3 shows a pictorial representation of a scene configuration and marks inserted thereinto within a playback session of the first embodiment.

FIG. 4 is a diagram showing one exemplary scene select display screen for use in a playback mode of the first embodiment.

FIG. 5 shows a pictorial representation of a scene configuration example in a dubbing mode of the first embodiment.

FIG. 6 is a diagram showing an exemplary scene configuration for the dubbing in the first embodiment.

FIG. 7 is a diagram showing an exemplary playback scene select display screen of a disk No. 1 after completion of a dubbing operation performed thereto.

FIG. 8 is a diagram showing an exemplary playback scene select display screen of a disk NO. 2 after completion of a dubbing operation performed thereto.

FIG. 9 is a diagram showing a folder structure for management of information relating to marks.

FIG. 10A shows a flow chart of a video shooting procedure of the first embodiment.

FIG. 10B shows a flowchart of dubbing procedure of the first embodiment.

FIG. 11 shows a block diagram of second embodiment of this invention.

FIG. 12 shows a flowchart of a dubbing procedure of the second embodiment.

### DESCRIPTION OF EMBODIMENTS

Currently preferred embodiments of the present invention will be described with reference to the accompanying drawings below.

### Embodiment 1

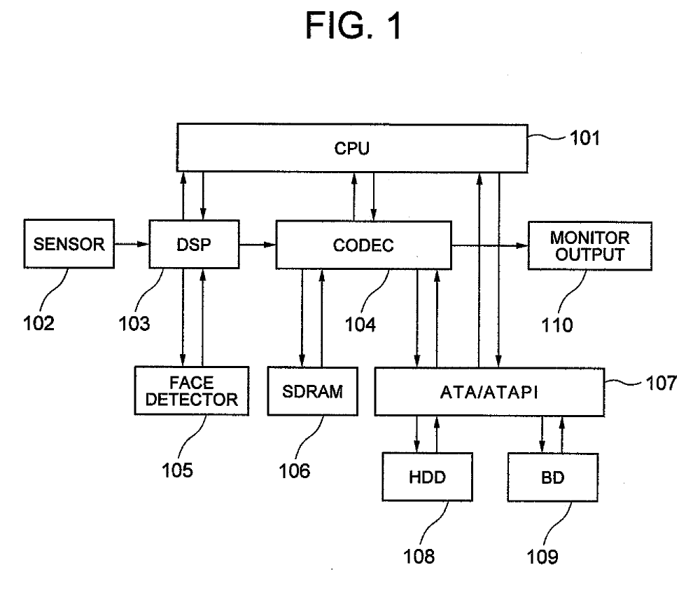

FIG. 1 is a block diagram of a first embodiment of this invention. Here, an explanation will be given by taking a hybrid digital video camera or “camcorder” as one example, while this invention is not exclusively limited thereto and may also be applicable to other types of imaging devices which are arranged to perform similar processing.

As shown in FIG. 1, the hybrid camcorder is arranged to include a central processing unit (CPU) 101, audio/video (AV) sensor 102, digital signal processor (DSP) 103, coder/decoder or “codec” unit 104, face detection unit 105, synchronous dynamic random access memory (SDRAM) 106, advanced technology attachment (ATA) and AT attachment packet interface (ATAPI) control unit 107, hard disk drive (HDD) 108, Bru-ray™ disc (BD) drive 109, and monitor output unit 110.

The CPU 101 performs control of respective components or modules, including the DSP 103, codec 104 and ATA/ATAPI controller 107. The AV sensor 102 is for converting video data of captured scene/subject images into electrical signals, which is sent forth to the DSP 103. DSP 103 is responsive to receipt of this input video signal from sensor 102, for applying thereto signal processing and for performing control of the face detector 105 and processing of a face detection signal. In this way, in this embodiment, the face detector 105 automatically detects the face of a subject of shooting, e.g., person, when a moving picture is taken. Upon receipt of an input video signal from DSP 103, the codec 104 applies compression processing thereto. This compression is performed while using the SDRAM 106 as a work buffer. A resultant video signal that was compressed by the codec 104 is passed via ATA/ATAPI controller 107 to either HDD 108 or a recording medium being presently loaded in BD drive 109 and then recorded thereto. In a playback mode, a video signal which is read out of either HDD 108 or the recording medium of BD drive 109 is transferred to the codec 104 through ATA/ATAPI controller 107, and is applied extension processing in codec 104. This extension processing is performed by using the SDRAM 106 as a work buffer therefor. The resulting extended or “stretched” video signal is sent to the monitor output unit 110 for visual display on its screen, such as a color liquid crystal display (LCD) panel. In a dubbing mode, a video signal as read out of the HDD 108 is transferred to the codec unit 104 via ATA/ATAPI controller 107 and is then applied extension processing by codec 104. For this processing, the SDRAM 106 is used as a work buffer.

During the video shooting, when the face detector 105 detects the presence of a human face in a scene being captured, an interruption signal is uploaded from the face detector 105 to CPU 101 via DSP 103. In responding thereto, CPU 101 recognizes the face detection. Upon recognition of the face detection, CPU 101 generates information indicative of a mark which becomes a break point or “transition” of the scene. This mark information is sent to the HDD 108 via ATA/ATAPI controller 107 and is then stored in HDD 108.

In cases where a scene transition is created due to stoppage of video shooting, the CPU 101 generates a usual or standard mark information, which is sent and recorded to the HDD 108 via ATA/ATAPI controller 107.

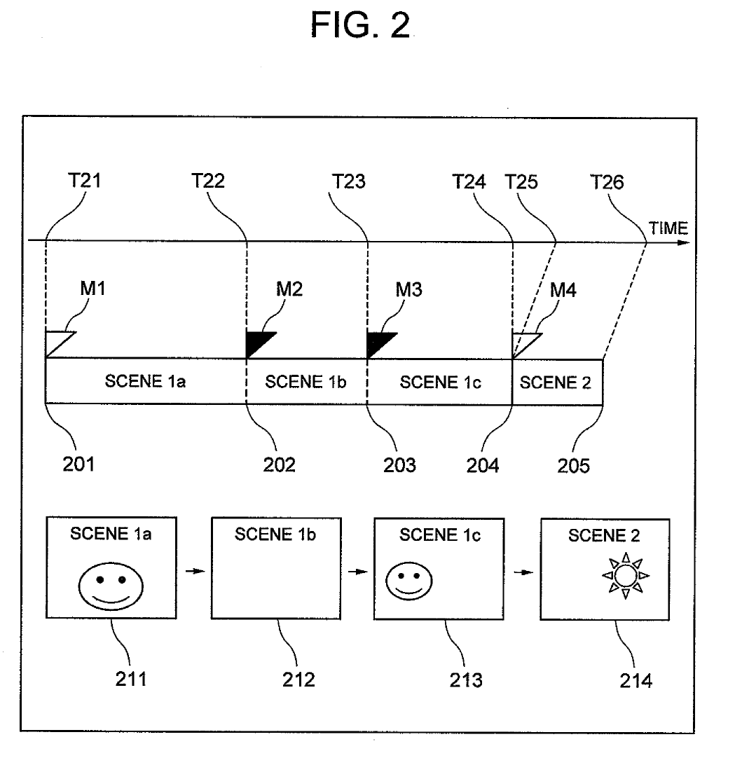

Turning to FIG. 2, an example of video data of the hybrid camcorder embodying the invention is shown for indicating a scene configuration along with the presence or absence of human face images and marks therein. In FIG. 2, reference character “T21” designates a time point at which the video shooting of a first scene started. T22 is a time point after the elapse of about twenty minutes from the start of the video shooting of the first scene—at this time point T22, a subject of shooting was gone away, resulting in nobody being present in this scene. T23 is a time point whereat a number of subject, i.e., person, increased so that the person number becomes one after about thirty minutes have passed from the start of the video shooting of the first scene. T24 is a time point at which this video shooting ended after elapse of about forty-five minutes from the start of the video shooting of the first scene. T25 is a time point at which video shooting of a second scene gets started. T26 is an instant whereat this shooting is ended after the elapse of about ten minutes since the starting time point of the shooting of the second scene. M1 is a mark which is inserted at a head position of the first scene. M2 is a mark which was added at the timing of the decrease of one person. M3 is a mark added at the timing of the increase of one person. M4 a mark that is formed at a head position of the second scene. A display image 211 is a summary of video frame images sensed between the time points T21 and T22. A display image 212 is a summary of video frames between the time points T22 and T23. A display image 213 is a summary of video between the time points T23 and T24. A display image 214 is a summary of video between the time points T25 and T26. A sequence of video frame images spanning from the time point T21 to time point T22 is indicated by a scene 1a; a video sequence of from the time point T22 to time point T23 is a scene 1b; a video sequence between the time points T23 and T24 is a scene 1c; a video sequence between the time points T25 and T26 is a scene 2. Reference numeral 201 indicates T21; numeral 202 designates T22; 203 denotes R23; 204, T24; 205, T26. As shown in the display images 211 and 213, the subject of shooting is a one person existing in each of the scenes 1a and 1c, with the subject's face image is displayed therein. On the other hand, as shown in the display images 212 and 214, no persons to be shot are present therein so that no faces exist.

The marks M1 and M4 are such that each is to be added when a user starts the video shooting, which mark is for routine use as a scene transition. The marks M2 and M3 are the ones that are automatically generated and inserted by the CPU 101 of the camcorder in responding to the occurrence of interruption from the face detector 105. The marks M1 and M4 are usually used marks which are to be displayed as scene transitions during both playback and dubbing sessions; the marks M2 and M3 are the marks that are used for dubbing only, which are recorded as a specific type of marks that are different from the usual marks.

It should be noted here that the marks M2 and M3 are designed so that these are not visually displayed during playback in order to prioritize the continuity of a scene being played back; however, in cases where it is required during playback to perform quick head search also at a position whereat the number of faces of subjects changed to increase or decrease, the marks M2-M3 may alternatively be designed so that these are displayable during the playback in order to meet the user's needs. Furthermore, it may also be a good idea to use different types of marks for different kinds of cases—i.e., when the subject face number increased and when the face number decreased. This makes it possible to manage the subject face number increase/decrease timings by means of such different types of marks, thereby enabling accommodation of a wide variety of user needs.

Alternatively, the marks may be designed, for example, so that a mark is added only at the timing of an increase in subject face number in accordance with the user's end-usage while preventing addition of such mark at the timing of a decrease in subject face number. Adversely, the marks may be designed so that a mark is added only at the timing of a decrease in person face number while preventing such mark addition at the timing of an increase in face number. Note that the mark to be added here may be either a dubbing-dedicated mark or a usual mark. With such the arrangement, it is possible to accommodate various kinds of user needs, thereby enabling improvement of the usability and user friendliness. In such arranged system, since image data having been recorded is not simply split into a plurality of parts with at almost equal interval of time period, it then becomes possible to resolve the problem in a general system, that is, a scene to be played back continuously is undesirably interrupted in a midstream thereof and its playback suddenly stops when watching and enjoying the recorded image as a home-made video movie.

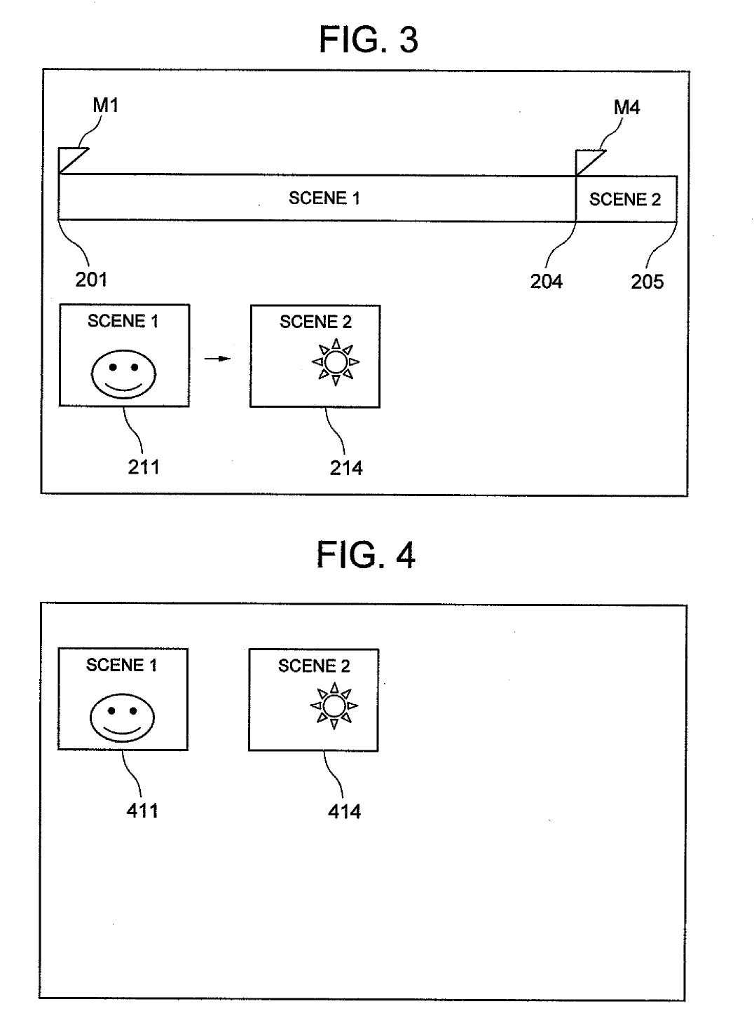

FIG. 3 shows a pictorial representation of a scene configuration and marks added thereto in a playback session of the first embodiment of the invention. An explanation of the same reference characters as those of FIG. 2 is eliminated herein. The explanation here is under an assumption that marks M2 and M3 are dubbing-dedicated marks which are not displayed during playback, so that a video clip shown in FIG. 3 consists of two scenes, i.e., a scene 1 and a scene 2.

FIG. 4 is a diagram showing an exemplary scene select display screen in the playback mode of the first embodiment of the invention. As shown herein, a thumbnail image 411 of the scene 1 and a thumbnail image 414 of the scene 2 are displayed. The discussion here is under an assumption that the marks M2 and M3 are dubbing-dedicated marks which are not displayed during playback; so, the user's selectable ones in FIG. 4 includes a couple of scenes, i.e., the scene 1 and scene 2. When the user selects the scene 1 and then starts playback of it, continuous playback is performed from T21 to T24. Alternatively, when the user selects the scene 2 and starts playback, continuous playback is done between T25 and T26.

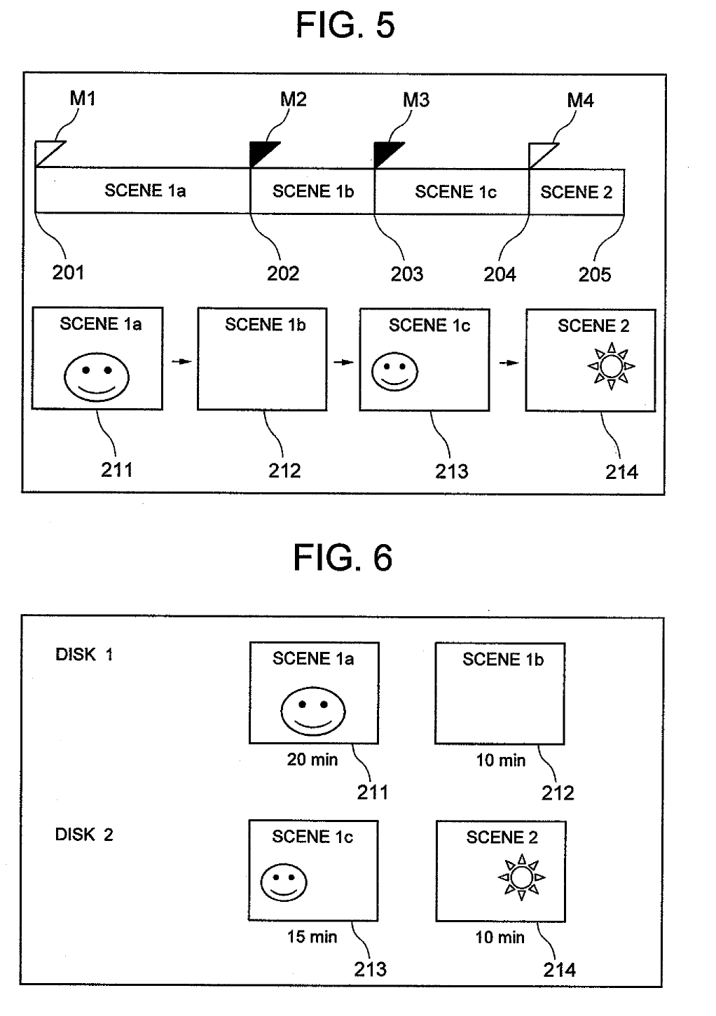

FIG. 5 is a pictorial representation of a scene structure and marks added thereto during dubbing of the first embodiment of this invention. An explanation of the same reference numerals as those of FIG. 2 is eliminated herein. During a dubbing session, the marks M2 and M3 are handled as usual marks in a similar manner to the marks M1 and M4; so, in FIG. 5, a configuration of video clip having a set of four separate scenes is shown—i.e., a scene 1a, a scene 1b, a scene 1c and a scene 2.

FIG. 6 is a diagram showing a scene configuration example in the dubbing session of the first embodiment of this invention. A thumbnail display in this diagram is for notifying the user that the camera automatically performs scene splitting prior to a dubbing operation. An example shown in FIG. 6 assumes that a camcorder is capable of recording up to thirty minutes of video per disk, for showing that a video with its length of thirty minutes as measured from the head part of the scene 1—that is, an ensemble of twenty minutes of scene 1a and ten minutes of scene 1b—is copied or “dubbed” to a disk No. 1 whereas the remaining part of the scene 1, i.e., a combination of fifteen minutes of scene 1c and ten minutes of scene 2, is dubbed to a disk #2.

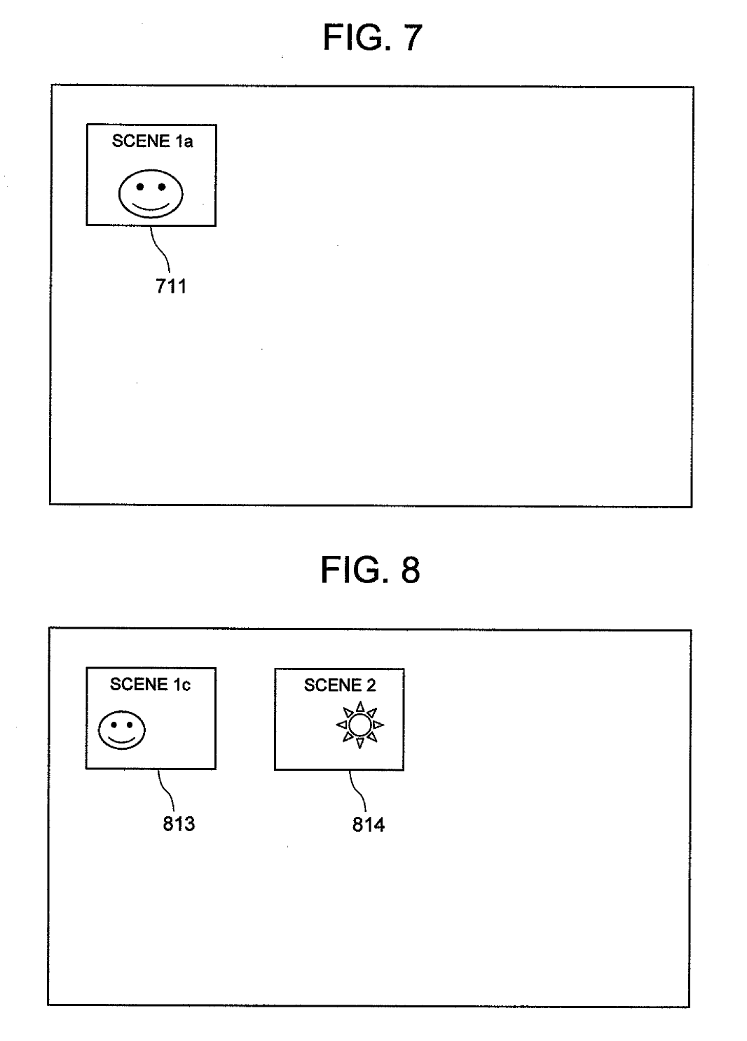

FIG. 7 is a diagram showing a scene select display screen example of the disk #1 after completion of the dubbing, on which screen is displayed a thumbnail image 711 of the scene 1a. What is selectable by the user in this case is only the scene 1a. When the user chooses the scene 1a and starts playback of it, a video clip or “movie” with its time length of from T21 up to T23 is played back continuously. In this way, videos of the scenes 1a and 1b are dubbed together to the disk 1 in a merged state.

FIG. 8 is a diagram showing an exemplary playback scene select display screen of the dubbing-completed disk 2, on which both a thumbnail image 813 of the scene 1c and a thumbnail image 814 of the scene 2 are displayed. In this case, a couple of scenes, i.e., the scene 1c and scene 2, are selectable by the user. When the user chooses the scene 1c and starts playback of it, a video movie spanning from T23 up to T24 is played back continuously. When s/he selects the scene 2 and starts playback, a movie is continuously played from T25 to T26.

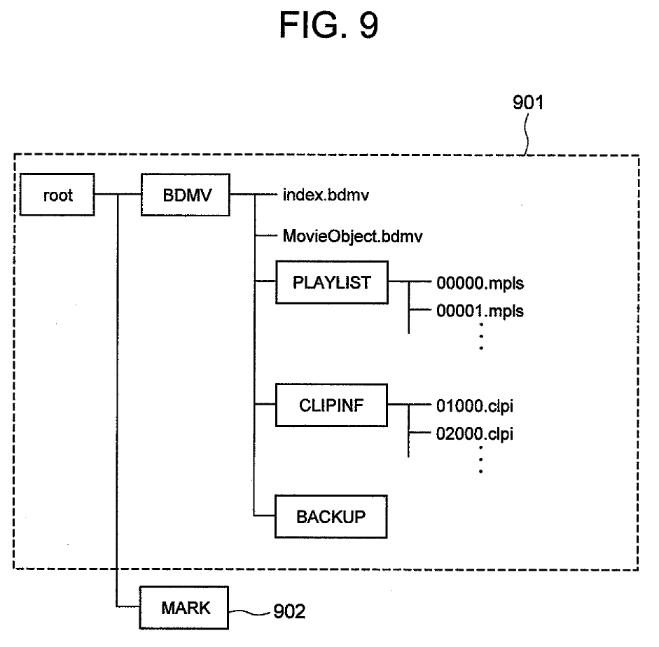

FIG. 9 is a diagram showing a hierarchical directory structure for use in management of information relating to the marks. Using this diagram, an explanation will be given of one exemplary procedure for managing the marks when performing dubbing video contents to a recording medium, such as Blu-ray™ disc (BD), secure digital (SD) card or else. A part 901 which is surrounded by dotted lines in FIG. 9 is a common directory part pursuant to the BD movie (BDMV) standards and/or advanced video codec high definition (AVCHD) standards. A file named “index.bdmv” is the one that contains therein entire file management information, including a total scene number, last record time and date, etc. A file “MovieObject.bdmv” contains the information as to a file execution sequence. A directory or folder named “PLAYLIST” contains files “00000.mpls” and “00001.mpls” and others, which are play list files indicating a stream playback order. Usual marks, such as the above-stated marks M1 and M4, are contained in this PLAYLIST directory. A directory named “STREAM” and a directory “CLIPINFO” are paired together. The STREAM directory contains files “01000.m2ts,” “02000.m2ts,” . . . , which are the video contents of a stream. The CLIPINFO directory contains files named “01000.clpi,” “02000.clpi,” . . . , each of which is management information indicating the head position of a GOP (Group of Pictures) relating to its corresponding stream, a format type of the stream or the like. A directory named “BACKUP” is used to contain copied files of those other than “*.m2ts” files that are the stream's video contents.

In this embodiment, a directory 902 named “MARK” is further formed at a level just below the root directory. In the MARK directory 902, certain information as to dubbing-use marks are stored, such as the above-stated marks M2-M3. Generally, in a case where an extra directory different from the standard-defined directories is formed, this directory is not played back by standard apparatus, such as video players complying with the standards. In view of this, an extra or “special” directory which is different from usual directories or folders pursuant to the BDMV/AVCHD standards is intentionally prepared for storing therein the information relating to the dubbing-use marks, such as the marks M2 and M3. By doing so, it is possible, when dubbing is performed, to refer to the dubbing-use marks M2-M3 on the dubbing device side. This in turn makes it possible to make these marks M2-M3 invisible, or hidden, in any way from video players during playback sessions.

Alternatively, in case a need is felt to refer to the marks M2 and M3 in a playback session also, the information as to these marks M2-M3 may be saved in one of the standard directories complying with the standards, e.g., the PLAYLIST folder.

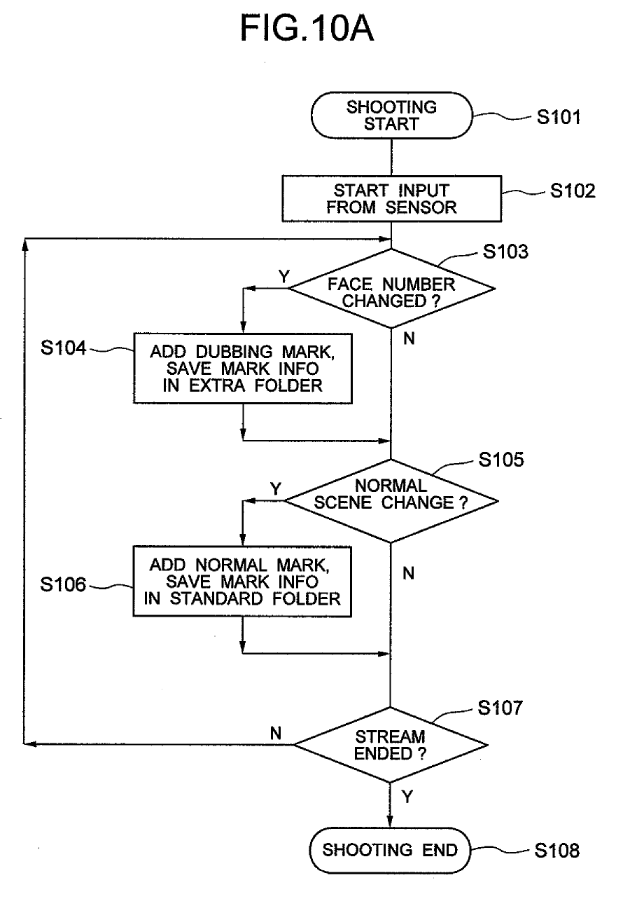

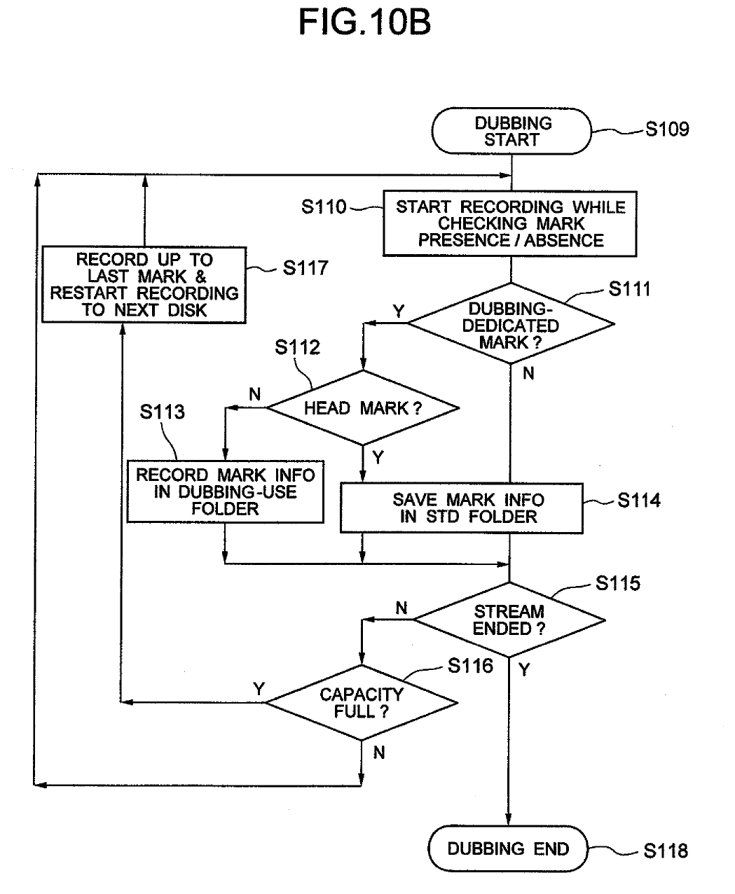

FIGS. 10A and 10B are flow diagrams showing video shooting and dubbing procedures in this embodiment. The flow of video shooting will be described with reference to FIG. 10A, and the flow of dubbing will be explained using FIG. 10B below. As shown in FIG. 10A, the video shooting procedure starts at step S101. Consequently, at step S102, audio/video data including a video stream begin to be input to the DSP 103 from AV sensor 102 of FIG. 1. Then, at step S103, a change (increase or decrease) in number of face images of subjects in the video stream is detected. If such change is found, the procedure goes to step S104. At this step S104, a dubbing-use mark, such as the mark M2 or M3 stated supra, is added. As previously stated, this dubbing-use mark is stored in the MARK directory 902, which is different from the standard folders within the block 901 of FIG. 9. If NO branch is selected at step S103 or the process passes the step S104, the procedure goes to step S105. In this step S105, detection is performed to determine whether an ordinary scene change or “transition” is present or not. If such scene transition is found then go to step S106, which adds a usual mark, such as the above-stated mark M1 or M4, and then stores it in the standard directory 901 as defined pursuant to the currently established standards. If NO at step S105 or alternatively after completion of step S106, proceed to step S107 which performs detection to determine whether the video stream of interest is ended or not. When the stream input from the AV sensor 102 in response to receipt of a recording stop instruction or else, go to step S108 which quits a presently performed video shooting operation. On the other hand, in case the stream is not yet ended, return to step S103.

As for the dubbing procedure shown in FIG. 10B, a dubbing operation gets started at step S109. Then, at step S110, recording to a dubbing destination starts while at the same time verifying whether a mark is present or absent on a real-time basis. When a mark is found, the procedure goes to step S111 which determines whether the mark found is a dubbing-dedicated mark or not. If YES at step S111, go to step S112; if NO then go to step S114. At step S112, a decision is made as to whether the dubbing-dedicated mark is a top mark in a recording medium for use as the dubbing destination. If NO at step S112, proceed to step S113; if NO, go to step S114. In step S113, the mark information is recorded in a specific directory, such as the above-stated extra directory 902 shown in FIG. 9, to thereby ensure that no dubbing-dedicated marks are rendered visible or hidden during playback sessions. At step S114, the mark information is saved in a standard directory, such as the above-stated directory 901, to make sure that this mark is visible during playback also. Subsequently, at step S115, a decision is made as to whether the stream ended or not. If NO at step S115 then proceed to step S116, which judges whether a presently recorded video amount has reached the maximum storage capacity of the dubbing-destination recording medium—in other words, this medium has fully recorded or not. If YES at step S116 then go to step S117, which records the video up to a last mark which is recordable on the dubbing destination medium and prompts the user to exchange it for a recording medium with a free space, such as a blank disk, and then restarts the recording of the stream. If NO at step S116 then return to step S110. Additionally, if YES at step S115, that is, when the stream comes to its end, the routine goes to step S118 which quits the dubbing.

As apparent from the foregoing, it is possible for the hybrid camcorder embodying the invention to perform, by use of dubbing-dedicated marks, the dubbing to two or more separate recording media without impairing the inherent scene continuity and also to play a resultant home video movie while avoiding occurrence of the user's unintentional scene splitting during playback.

In this embodiment, there has also been stated an example which performs face detection during video shooting. With the face detection, it becomes possible to acquire in advance the face detection information when performing video shooting. This makes it unnecessary to reacquire such face detection information prior to execution of dubbing, thereby enabling smooth and rapid execution of the dubbing with the face detection information being taken into consideration.

Although in the above-stated embodiment a specific case was explained where a mark is added at a position at which the number of face images is changed from zero to one or, alternatively, from one to zero, it is not always necessary for this face number to become zero. For example, the mark may be added at a position at which the face number increased from one to two, a position whereat the number increased from two to three, a position whereat it reduced from five to four, etc. In this case, it is possible to achieve more fine scene splitting at shorter time intervals, which leads to an advantageous ability to use the capacity of a to-be-dubbed disk more efficiently.

### Embodiment 2

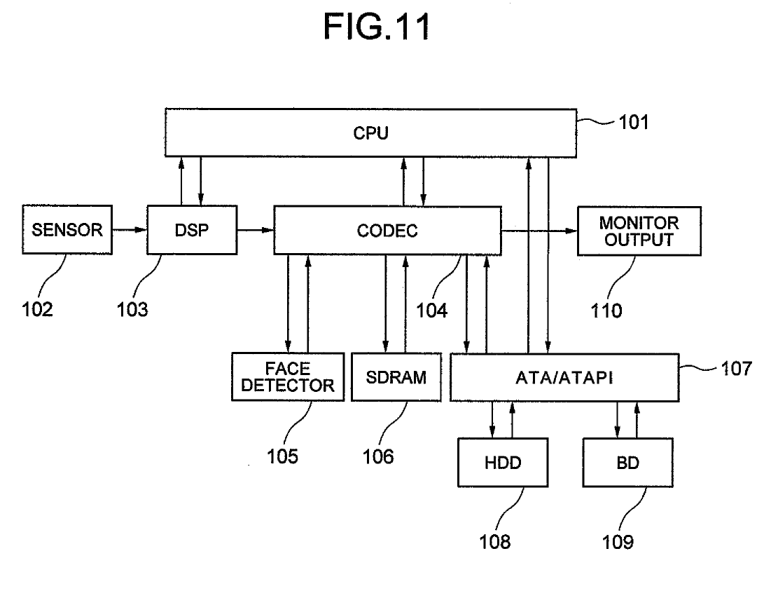

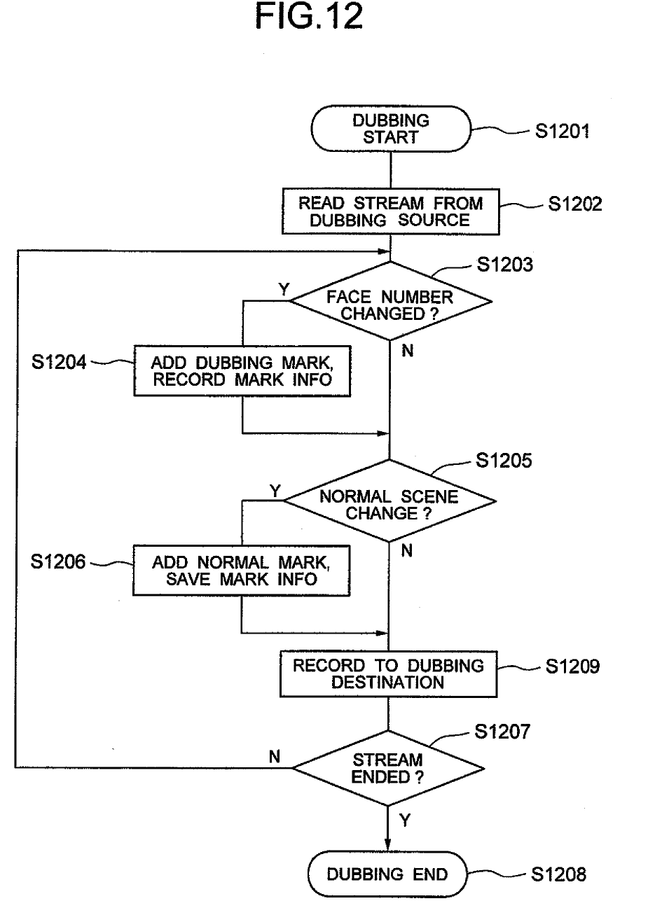

FIG. 11 is a block diagram of a hybrid digital camcorder in accordance with a second embodiment of this invention. Parts or components similar to those shown in FIG. 1 are designated by the same reference numerals, and an explanation thereof will be eliminated herein.

The camcorder of FIG. 11 is different from that shown in FIG. 1 in that the face detector 105 is connected not to DSP 103 but to codec unit 104. Another difference is that the codec 104 is arranged to perform the control of face detector 105 and the processing of a face detection signal(s). These features unique to this embodiment are for enabling face detector 105 to detect face images of subjects during dubbing, rather than during video shooting.

In video shooting and playback modes, signal processing is performed in a similar way to the first embodiment, except that face detection is done not during shooting but during dubbing. The dubbing also is similar to the embodiment 1 in that a video signal as read from the HDD 108 is sent to codec 104 via ATA/ATAPI controller 107 and subject to expansion processing at codec 104, with SDRAM 106 being used as a work buffer.

In this embodiment the video signal that was expanded during dubbing is passed to the face detector 105, which applies thereto face detection processing. In addition, the expanded video signal is again sent to the codec 104, which applies thereto compression processing, causing the resulting signal to be recorded on a recording medium of the BD drive 109 in a similar manner to that during recording. More specifically, upon startup of the dubbing, a stream is read out of a dubbing source, such as HDD 108, followed by execution of face detection.

When a face image is detected by the face detector 105 during dubbing, an interruption signal is uploaded from face detector 105 to CPU 101 via codec 104, resulting CPU 101 recognizing such face detection. Upon recognition of the face detection, CPU 101 determines that it must be a scene transition and then adds a mark to the scene to thereby perform scene splitting. Mark-related information is temporarily saved in a buffer memory, such as SDRAM 106 or else for example. The mark added in response to the face detection is a temporarily used mark which will possibly be deleted in the middle of the dubbing processing; so, this mark is called the temporary mark.

Upon completion of the dubbing of video contents up to a tail end of the scene from the HDD 108 to the disk in BD drive 109, the temporary mark of this scene is deleted, thereby enabling the user to care nothing about unnecessary scene splitting.

In a case where the first disk's remaining capacity becomes empty in the middle of the dubbing of a scene, the position of a last added temporary mark of those temporary marks added in the process of dubbing such scene is regarded as the tail end of this scene while simultaneously deleting those temporary marks other than the last added mark, thereby enabling the user not to bother about unnecessary scene splitting. After having loaded another disk, e.g., blank BD, in place of the fully recorded disk, the dubbing is restarted from the position of the last added temporary mark.

Regarding the timings of reading the stream from the dubbing source and performing the face detection along with recording to the dubbing destination, the readout and face detection plus the recording may be performed in a parallel way; alternatively, the recording may be done after having completed the readout and face detection up to the tail end of a stream. In the case of the readout and face detection plus the recording being performed in parallel, it becomes possible to shorten a total time as taken for the dubbing. In the case of the recording being done after completion of the readout and face detection, it is possible to perform the recording efficiently. This can be said because a mark position to be accommodated within the storage capacity of the dubbing destination medium is determinable in advance.

The dubbing flow in this embodiment will be described with reference to FIG. 12 below.

Firstly, at step S1201, the dubbing gets started. Then at step S1202, a stream is read out of a dubbing source medium, such as HDD 108. In steps S1203 to S1207, processes are carried out, which are basically similar to those at steps S103 to S107 of FIG. 10A. Note however that in this embodiment, the mark information is once saved in a buffer memory, such as SDRAM 106, at step S1204 and also at step S1206. These items of mark information being temporarily saved in this buffer memory are recorded together at a time in a dubbing destination after having completed the dubbing of video stream contents to the dubbing destination. By letting such management information items be finally recorded together in this way, it is possible to efficiently use the recording capacity of the dubbing destination medium. Although in the example of FIG. 12 the step S1209 of performing the recording to the dubbing destination is performed before the step S1207, this indicates the above-stated case of the stream readout and face detection plus recording being done in a parallel way. In case the recording is carried out after completion of the readout and face detection, the step S1209 may be arranged so that it is between the step S1207 and step S1208. This step S1208 is for quitting the dubbing.

Repeating the above-stated procedure makes it possible to achieve the scene splitting at a position with no face images even when performing the dubbing by splitting the scene into parts to be recorded on two or more disks. This brings an advantageous effect unique to this embodiment: it becomes possible to realize scene splitting without damaging the scene continuity.

In this embodiment, the face detection is performed in the process of dubbing. Thus, it becomes possible to reduce the processing load during video shooting, when compared to the method for acquiring face detection information during shooting. Another advantage of the camcorder arranged to perform face detection not during shooting but during dubbing is as follows: in case a camcorder with no face detection function is used to shoot a subject(s) for making a home video movie and, thereafter, this camcorder is upgraded to have an add-in firmware module with the face detection function, it becomes possible to perform face detection with respect to the already shot video even after completion of the video shooting activity.

Note that in this embodiment, a specific case was explained where a mark is added at a position at which the number of face images is changed from 0 to 1 or, alternatively, from 1 to 0, it is not always necessary for this face number to become zero. For example, the temporary mark may be added at a position at which the face number increased from 1 to 2, a position whereat the number increased from 2 to 3, a position whereat it reduced from 5 to 4, etc. In this case, it is possible to achieve more fine scene splitting at shorter time intervals, which leads to an advantageous ability to use the capacity of a to-be-dubbed disk more efficiently.

Also note that although this embodiment camcorder is arranged to perform face detection only in the process of dubbing while preventing execution of the face detection during video shooting, this embodiment may be modified to perform the face detection both during shooting and during dubbing. In this case, when an attempt is made to perform highly precise face detection, the camcorder increases in load because it must perform in a shooting session an increased amount of processing tasks—that is, processing for the face detection in addition to the signal processing for video shooting. An approach to avoiding this is to design the camcorder to perform face detection during video shooting while prioritizing the signal processing for the shooting and separately perform precise face detection when dubbing is performed thereafter. With this arrangement, it is possible to achieve face detection with increased accuracy. The face detection may be based on a change in number of subject faces as stated previously, with or without additional detection of the kinds of such faces. With simultaneous execution of the face kind detection and the face number detection, it is possible to improve the usability for users while increasing the accuracy of face detection.

By applying this invention to hybrid digital video cameras or “camcorders” of the type having a built-in large-capacity fixed storage media, such as HDD, and a relatively small capacity of removable media such as DVD, BD or like optical recordable disks, it becomes possible to achieve the dubbing with automatic scene splitting feature without impairing the scene continuity in the event of watching and enjoying a home-made movie.

It is noted that the present invention should not exclusively be limited to the illustrative embodiments stated supra and may also include a variety of modifications and alterations as well as equivalents thereto. For example, any one of the above-stated embodiments is for detailed explanation of the invention, and the invention should not be interpreted to be limited only to apparatus or equipment having all of the constituent elements or components as disclosed herein. Additionally, it is possible to replace a part of the configuration of one of the embodiments by the configuration of another embodiment. It is also possible to add the configuration of one embodiment to that of another embodiment.

It should be further understood by those skilled in the art that although the foregoing description has been made on embodiments of the invention, the invention is not limited thereto and various changes and modifications may be made without departing from the spirit of the invention and the scope of the appended claims.

1. An information record/reproduction apparatus for recording or reproducing information to or from a recording medium, said apparatus comprising:
a sensor unit for shooting a subject of interest and for generating a video stream;
a detection unit for detecting a human face of the subject in the video stream;
a control unit for control of said detection unit; and
a record/playback unit operative to record the information containing therein said image stream to said recording medium or reproduce the video stream-containing information from said recording medium, wherein
when video shooting gets started, a first kind of mark information is recorded to said recording medium, and
during the video shooting, when there is a change in number of faces of subjects, a second kind of mark information different from the first mark information is recorded to said recording medium.

2. The information record/reproduction apparatus according to claim 1, wherein in a case where said video stream as recorded to said recording medium is dubbed to a dubbing destination recording medium different from said recording medium, when said video stream bridges between a plurality of dubbing destination recording media, the dubbing is performed in such a way that said video stream is split at a position of any one of the first mark information and the second mark information.

3. The information record/reproduction apparatus according to claim 2, wherein said dubbing is performed in such a way as to ensure that said second mark information is prevented from being reproduced during playback of said dubbing destination recording medium.

4. The information record/reproduction apparatus according to claim 2, wherein during playback of said dubbing destination recording medium, said dubbing is performed so that said second mark information is permitted to be reproduced if this second mark information is placed at a head portion of said dubbing destination recording medium and said second mark information is prevented from being reproduced in cases where this information is placed at portions other than the head portion of said dubbing destination recording medium.

5. The information record/reproduction apparatus according to claim 2, wherein said second mark information is recorded in a directory different from a directory in which said first mark information is recorded whereby said second mark information is no longer reproduced during playback of said dubbing destination recording medium.

6. An information record/reproduction method for recording or reproducing information to or from a recording medium, said method comprising the steps of:
recording a first kind of mark information to the recording medium upon startup of video shooting; and
when there is a change in number of human faces of subjects during the video shooting, recording a second kind of mark information to said recording medium.

7. The information record/reproduction method according to claim 6, wherein in a case where a video stream as recorded to said recording medium is dubbed to a dubbing destination recording medium different from said recording medium, when the video stream bridges between a plurality of dubbing destination recording media, the dubbing is performed in such a way that said video stream is split at a position of any one of the first mark information and the second mark information.

8. The information record/reproduction method according to claim 7, wherein said dubbing is performed in such a way as to ensure that said second mark information is prevented from being reproduced during playback of said dubbing destination recording medium.

9. The information record/reproduction method according to claim 7, wherein during playback of said dubbing destination recording medium, said dubbing is performed so that said second mark information is permitted to be reproduced if this second mark information is placed at a head portion of said dubbing destination recording medium and said second mark information is prevented from being reproduced in cases where this information is placed at portions other than the head portion of said dubbing destination recording medium.

10. The information record/reproduction method according to claim 7, wherein said second mark information is recorded in a directory different from a directory in which said first mark information is recorded whereby said second mark information is no longer reproduced during playback of said dubbing destination recording medium.

11. The information record/reproduction apparatus according to claim 3, wherein said second mark information is recorded in a directory different from a directory in which said first mark information is recorded whereby said second mark information is no longer reproduced during playback of said dubbing destination recording medium.

12. The information record/reproduction method according to claim 8, wherein said second mark information is recorded in a directory different from a directory in which said first mark information is recorded whereby said second mark information is no longer reproduced during playback of said dubbing destination recording medium.

13. An information record/reproduction apparatus for recording or reproducing information to or from a recording medium, said apparatus comprising:
a sensor unit for shooting an object of interest and for generating a video stream;
a detection unit for detecting a prespecified part of the object in the video stream;
a control unit for control of said detection unit; and
a record/playback unit operative to record the information containing therein said image stream to said recording medium or reproduce the video stream-containing information from said recording medium, wherein
when video shooting gets started, a first kind of mark information is recorded to said recording medium, and
during the video shooting, when there is a change in number of prespecified parts of objects, a second kind of mark information different from the first mark information is recorded to said recording medium, and wherein
in a case where said video stream as recorded to said recording medium is dubbed to a dubbing destination recording medium different from said recording medium, when said video stream bridges between a plurality of said dubbing destination recording media, the dubbing is performed in such a way that said video stream is split at a position of any one of the first mark information and the second mark information.

14. The information record/reproduction apparatus according to claim 13, wherein the prespecified part of said object is a human face.

15. An information record/reproduction apparatus for recording or reproducing information to or from a recording medium, said apparatus comprising:
a sensor unit for shooting an object of interest and for generating a video stream;
a detection unit for detecting a prespecified part of the object in the video stream;
a record/playback unit operative to control of detection unit, and to record the information containing therein said image stream to said recording medium or reproduce the video stream-containing information from said recording medium, wherein
when video shooting gets started, a first kind of mark information is recorded to said recording medium, and
during the video shooting, when there is a change in number of prespecified parts of objects, a second kind of mark information different from the first mark information is recorded to said recording medium, and wherein
in a case where said video stream as recorded to said recording medium is dubbed to a dubbing destination recording medium different from said recording medium, when said video stream bridges between a plurality of said dubbing destination recording media, the dubbing is performed in such a way that said video stream is split at a position of any one of the first mark information and the second mark information.

16. The information record/reproduction apparatus according to claim 15, wherein the prespecified part of said object is a human face.
